(19) United States
(12) Patent Application Publication
(10) Pub. No.: US 2011/0062370 A1
(43) Pub. Date: Mar. 17, 2011

(54) LECITHIN-CONTAINING COMPOSITION SUITABLE FOR PRODUCING RIGID POLYURETHANE FOAMS

(75) Inventors: Christian Eilbracht, Herne (DE); Martin Glos, Borken (DE)

(73) Assignee: Evonik Goldschmidt GmbH, Essen (DE)

(21) Appl. No.: 12/871,464

(22) Filed: Aug. 30, 2010

(30) Foreign Application Priority Data
Sep. 11, 2009 (DE) 102009029363.9

(51) Int. Cl. E04B 1/78; C08J 9/06

(52) U.S. Cl. 252/62; 521/108

(57) ABSTRACT

The invention provides a composition which is suitable for producing polyurethane foams and comprises at least one lecithin, at least one urethane and/or isocyanurate catalyst, at least one blowing agent, at least one isocyanate component and at least one polyol component and which is characterized in that the mass ratio of lecithin to polyol component is less than 2.5:100, and also a process for producing rigid polyurethane foams, the foams themselves and their use.

This application claims benefit under 35 U.S.C. 119(a) of German patent application DE 102009029363.9, filed on Sep. 11, 2009.

Any foregoing applications including German patent application DE 102009029363.9, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to lecithin-containing compositions suitable for producing rigid polyurethane foams, polyurethane foams produced from these and their use.

In the production of rigid polyurethane, polyurea and polyisocyanurate foams, use is made of cell-stabilizing additives which ensure a fine-celled, uniform foam structure which is low in defects and thus have a substantial positive influence on the use properties, in particular the thermal insulation capability, of the rigid foam. Surfactants based on polyether-modified siloxanes are particularly effective and therefore represent the preferred type of foam stabilizers.

Since there are many different rigid foam formulations for various fields of application, which formulations make individual demands on the foam stabilizer, polyether-siloxanes of different structures are used. One of the selection criteria for the foam stabilizer is the blowing agent present in the rigid foam formulation.

Various publications relating to polyether-siloxane foam stabilizers for rigid foam applications have already appeared. EP 0 570 174 B1 (U.S. Pat. No. 5,169,872) describes a polyether-siloxane having the structure (CH₃)₃SiO[SiO(CH₃)₂]ₓ[SiO(CH₃)R]_{y}Si(CH₃)₃, whose radicals R consist of a polyethylene oxide which is bound to the siloxane via an SiC bond and is endcapped at the other end of the chain by a C₁-C₆-acyl group. This foam stabilizer is suitable for producing rigid polyurethane foams using organic blowing agents, in particular chlorofluorocarbons such as CFC-11.

The next generation of chlorofluorocarbon blowing agents is hydrogen-chlorofluorocarbons such as HCFC-123. When these blowing agents are used for the production of rigid polyurethane foam, polyether siloxanes of the structural type (CH₃)₃SiO[SiO(CH₃)₂]ₓ [SiO(CH₃)R]_{y}Si (CH₃)₃ are suitable according to EP 0 533 202 A1 (U.S. Ser. No. 07/763,357). The radicals R here consist of SiC-bonded polyalkylene oxides which are composed of propylene oxide and ethylene oxide and can have a hydroxy, methoxy or acyloxy function at the end of the chain. The minimum proportion of ethylene oxide in the polyether is 25 percent by mass.

The more recent development in the production of rigid polyurethane foams is to dispense entirely with halogenated hydrocarbons as blowing agents and instead use hydrocarbons such as pentane. Thus, EP 1 544 235 (U.S. Patent Appl. Pub. 2005-131090) describes the production of rigid polyurethane foams using hydrocarbon blowing agents and polyether-siloxanes of the known structure (CH₃)₃SiO[SiO(CH₃)₂]ₓ[SiO(CH₃)R]_{y}Si(CH₃)₃ having a minimum chain length of the siloxane of 60 monomer units and different polyether substituents R whose average molecular weight is from 450 to 1000 g/mol and whose proportion of ethylene oxide is from 70 to 100 mol %.

Recently, polyurethane foams which have no siloxane foam stabilizers are being demanded ever more frequently. DE 2244350 (U.S. Pat. No. 3,746,663) describes the use of copolymers which are prepared from N-vinylpyrrolidone and maleic esters for producing polyurethane foam.

EP 0734404 (U.S. Pat. No. 5,674,918) describes the production of polyurethane foams using surfactants which do not contain silicone. Here, a copolymer based on ethylene oxide and butylene oxide is claimed as stabilizer.

However, the two abovementioned stabilizers which do not contain Si can be prepared only with a relatively high technical outlay. A further disadvantage is the fact that these copolymers are not based on renewable raw materials and have poor biodegradability.

DE 1149163 (U.S. Pat. No. 3,346,723) describes the production of polyurethane foams using lecithin as stabilizer. Specific aliphatic polyester polyols are used in this case and water is used as blowing agent. The polyurethane foams obtained were frequently only semi-rigid, and final crosslinking took a number of days.

It was an object of the present invention to provide rigid polyurethane foams in whose preparation the use of siloxane-containing foam stabilizers can be dispensed with and which do not have one or more of the disadvantages known from the prior art.

It has surprisingly been found that compositions according to Claim 1 achieve this object.

The present invention accordingly provides compositions which are suitable for producing rigid polyurethane foams and comprise at least one lecithin, at least one urethane and/or isocyanurate catalyst, a blowing agent, at least one isocyanate component and at least one polyol component, characterized in that the mass ratio of lecithin to polyol component is less than 2.5:100. The minimum amount could be 0.3:100=Lecithin:polyol component (see information given below).

The present invention further provides a process for producing rigid polyurethane, polyurea or polyisocyanurate foams, which is characterized in that a composition according to the invention is used.

The present invention likewise provides rigid polyurethane, polyurea or polyisocyanurate foams which are obtained by foaming a composition according to the invention and also the use of these rigid polyurethane or polyisocyanurate foams for producing insulation materials, preferably insulation boards, refrigerators or insulation foams.

The composition of the invention has the advantage that the use of lecithin in the amounts indicated makes it possible to produce rigid polyurethane foams based on ester or polyester polyols or polyether polyols. The compositions of the invention have the particular advantage that organic blowing agents, in particular hydrocarbons having from 3 to 5 carbon atoms, can be dissolved more readily in the composition. The compositions of the invention therefore make it possible to produce rigid polyurethane foams using little or no water.

The composition of the invention has the additional advantage that curing of the foams can be achieved within a maximum of 24 hours. Minimum curing times of modern foam formulations range from 30 seconds (very fast) to 90 seconds.

A further advantage of the present composition when using the renewable raw material lecithin as stabilizer for producing rigid polyurethane foams is the achievement of a saving in fossil resources.

The polyurethane foams produced using the composition of the invention, in particular the foams produced without water or using a very small proportion of water, also have the advantage that they have a poorer thermal conductivity and thus better insulation properties.

The compositions of the invention, the polyurethane foams themselves and their uses are described below by way of example without the invention being restricted to these illustrative embodiments. Where ranges, general formulae or classes of compounds are indicated below, these are intended to encompass not only the corresponding ranges or groups of compounds which are explicitly mentioned but also all subranges and subgroups of compounds which can be obtained by leaving out individual values (ranges) or compounds. Where documents are cited in the present description, their contents, in particular in respect of the subject to which reference is made, are fully incorporated by reference into the disclosure content of the present invention. Where percentages are mentioned in the following, these are, unless indicated otherwise, % by mass.

The compositions of the invention which are suitable for producing polyurethane foams and comprise at least one lecithin, at least one urethane and/or isocyanurate catalyst, at least one blowing agent, at least one isocyanate component and at least one polyol component are characterized in that the mass ratio of lecithin to polyol component is less than 2.5:100, preferably less than 2:100, more preferably less than 1:100, most preferably of from 0.3:100 to less than 1:100.

Apart from the components mentioned, the composition of the invention can have further constituents. In particular, the composition of the invention can comprise optionally (further) blowing agents, optionally flame retardants and optionally further additives such as fillers, emulsifiers, further Si-containing and non-Si-containing, in particular Si-containing and non-Si-containing organic stabilizers and surfactants, viscosity reducers, dyes, antioxidants, UV stabilizers or antistatics.

As lecithin, it is possible to use any phosphatidyl-choline (e.g. the fatty acid moiety can be any saturated or unsaturated fatty acid which includes but is not limited to C₂-C₂₂, C₈-C₂₂, C₁₂-C₂₂, caproic acid, enanthic acid, caprylic acid, pelargonic acid, capric acid, undecanoic acid, undecylenic acid, lauric acid, tridecanoic acid, myristic acid, pentadecanoic acid, plamitic acid, margaric acid, stearic acid, oleic acid, linoleic acid). The lecithin can comprise one phosphatidylcholine compound or various phosphatidylcholine compounds. Preference is given to using a mixture of phosphatidylcholine. The phosphatidylcholine compound or compounds can have various origins. Preference is given to using one or more phosphatidylcholine compounds derived from soya beans.

The lecithin can be used as crude lecithin as is obtained, for example, as by-product in the refining of vegetable oils such as soya bean oil. Soya lecithin which can be used in the composition of the invention also contains phosphatidylethanolamine, phosphatidylinositol, phosphatidylserine and also sterols, fats and oils in addition to phosphatidylcholine. Lecithin obtained from egg yolks, on the other hand, consists essentially of phosphatidylcholine. It can be advantageous to use hydroxylated lecithins as lecithins. In these, any unsaturated fatty acids present have been partially or completely modified by oxidation (e.g. using hydrogen peroxide) (RÖMPP Online, Version 3.4, keyword “Phosphatidylcholine”, 2009 Georg Thieme Verlag). Preference is given to using soya lecithin in the composition of the invention.

The index in the composition of the invention is preferably greater than 100, preferably from >150 to 250. The index describes the ratio of isocyanate actually used to calculated isocyanate (for a stoichiometric reaction with polyol). An index of 100 represents a molar ratio of the reactive groups of 1:1.

It can be advantageous for the mass ratio of polyol component to isocyanate component in the composition of the invention to be greater than 1. In this way, the ratio of urethane to isocyanurate groups in the foam can be shifted in the direction of isocyanurate formation. Such polyisocyanurate (PIR) foams frequently display better burning behaviour than polyurethane (PUR) foams.

As isocyanate component, it is possible to use the isocyanate compounds customarily used for producing rigid polyurethane or polyisocyanurate foams. The isocyanate component can contain one isocyanate compound or a plurality of different isocyanate compounds. Preferred isocyanate components are organic isocyanates which have two or more isocyanate functions.

Suitable isocyanates for the purposes of the present invention are all polyfunctional organic isocyanates, for example all isomers of diphenylmethane diisocyanate (MDI), in particular diphenylmethane 4,4′-diisocyanate, tolylene diisocyanate (TDI), hexamethylene diisocyanate (HMDI) and isophorone diisocyanate (IPDI). The mixture of MDI and more highly condensed analogues having an average functionality of from 2 to 4 which is known as “polymeric MDI” (“crude MDI”) is particularly useful.

As polyol components, it is possible for all known polyol compounds to be present in the composition of the invention. Organic substances having a plurality of groups which are reactive toward isocyanates and preparations thereof are preferably present as polyol component. Preferred polyols are all polyether polyols and polyester polyols which are suitable and customarily used for producing rigid foams. Polyether polyols are obtained by reacting polyhydric alcohols or amines with alkylene oxides. Polyester polyols are based on esters of polybasic carboxylic acids (usually phthalic acid or terephthalic acid) with polyhydric alcohols (usually glycols).

As polyol component, preference is given to polyester polyols based on aromatic acids or aliphatic acids which have less than 10 carbon atoms and preferably each have two or more acid groups being present, more preferably exclusively, in the composition of the invention. Particularly preferred aliphatic polyester polyols are those based on adipic acid.

Particularly preferred aromatic polyester polyols are based on phthalic acid or terephthalic acid and are marketed, inter alia, as Stepanpol® (from Stepan), Terol® (from Oxid), Terate® (from Invista) or Isoexter® from Coim.

The polyol component present in the composition of the invention preferably has an OH number of greater than 100.

Preference is given to at least one blowing agent being present in the composition of the invention, with the mass ratio of blowing agent to polyol component preferably being 1-30:100, preferably 5-25:100 and particularly preferably 10-20:100. Suitable physical blowing agents for the purposes of the present invention are gases, for example liquefied CO₂, and volatile liquids, for example hydrocarbons having from 3 to 5 carbon atoms, preferably cyclopentane, isopentane and n-pentane, fluorinated hydrocarbons, preferably HFC 245 fa, HFC 134a and HFC 365 mfc, chlorofluorocarbons, preferably HCFC 141b, oxygen-containing compounds such as methyl formate and dimethoxymethane or chlorinated hydrocarbons, preferably 1,2-dichloroethane. The blowing agent or agents is/are particularly preferably selected from among hydrocarbons having 5 carbon atoms and halogenated hydrocarbons.

Water can optionally be used as blowing agent in addition to or in place of the abovementioned blowing agents. The mass ratio of water to polyol component in the composition of the invention is preferably less than 5:100, more preferably less than 1:100 and particularly preferably less than 0.5:100. Preference is given to adding no water as blowing agent or no water (no more than 0.1% by weight) being present in the composition of the invention.

The water can be added directly to the composition or else be added as secondary component of one of the starting materials, e.g. the polyol component, together with this starting material to the composition.

Apart from physical blowing agents and optionally water, other chemical blowing agents which react with isocyanates to evolve gas, for example formic acid, can also be used.

Catalysts which can be present in the composition of the invention are those which catalyse the gelling reaction (isocyanate-polyol), the blowing reaction (isocyanate-water) or the dimerization or trimerization of the isocyanate. Typical examples are the amines triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl)ether, tin compounds such as dibutyltin dilaurate and potassium salts such as potassium acetate and potassium 2-ethylhexanoate.

Suitable amounts to be used depend on the type of catalyst and are usually in the range from 0.05 to 5 pphp (=parts by weight based on 100 parts by weight of polyol) or from 0.1 to 10 pphp in the case of potassium salts.

As flame retardants, it is possible, for example, for liquid organic phosphorus compounds such as halogen-free organic phosphates, e.g. triethyl phosphate (TEP), halogenated phosphates, e.g. tris(1-chloro-2-propyl)phosphate (TCPP) and tris(2-chloroethyl)phosphate (TCEP), and organic phosphonates, e.g. dimethyl methanephosphonate (DMMP), dimethyl propanephosphonate (DMPP), or solids such as ammonium polyphosphate (APP) and red phosphorus, or halogenated compounds, for example halogenated polyols, and also solids such as expandable graphite and melamine to be present in the composition of the invention.

The proportion of flame retardant in the composition is preferably from 0 to 50 parts by mass, preferably from 0.1 to 20 parts by mass and particularly preferably from 1 to 10 parts by mass, per 100 parts by mass of polyol.

A typical rigid polyurethane or polyisocyanurate foam formulation according to the present invention would give a foam density of from 20 to 50 kg/m³ and would have the following composition:

TABLE 1

| Component | Proportion by weight |
|---|---|
| Polyol | 100 |
| (Amine) catalyst | 0.05 to 5 |
| Potassium trimerization catalyst | 0 to 10 |
| Lecithin | 0.5 to 2.5 |
| Water | 0.01 to <5, |
| | preferably 0.1 to 2.5 |
| Blowing agent | 0 to 40 |
| Flame retardant | 0 to 50 |
| Isocyanate index: | greater than 150 |

The compositions of the invention can be used in a process for producing rigid polyurethane or polyisocyanurate foams. The processes can be carried out in a manner known to those skilled in the art or as indicated in the prior art. The processing of the compositions of the invention to produce rigid foams can be carried out, for example, by a manual mixing process or preferably by means of high-pressure foaming machines. In the case of metal composite elements, production can be carried out either batchwise or continuously in the double-belt process.

Typical formulations require a reaction time which is matched to the respective foaming process. In the production of refrigerators, the foam should be sufficiently cured after typically from 3 to 10 minutes for further assembly of the appliance to be possible. In the case of continuous foaming processes, the boards are preferably cut to the desired length at the end of the double-belt laminators. Depending on the belt speed, this can give a curing time of from 1 to 10 minutes. In batch processes, even longer curing times of up to 30 minutes can be tolerated.

The reactivity of a formulation can be described, inter alia, by the tack free time. This is the time after which the foam no longer sticks when the surface is touched. The tack free time after foaming of compositions according to the invention to produce rigid polyurethane or polyisocyanurate foams is preferably less than 10 minutes, preferably less than 5 minutes.

The rigid polyurethane or polyisocyanurate foams of the invention can be obtained by foaming the compositions of the invention. These foams are characterized in that they preferably contain less than 3 parts by mass, more preferably less than 2 parts by mass and particularly preferably less than 1 part by mass, of lecithin, based on 100 parts by mass present in the foam.

The rigid polyurethane or polyisocyanurate foams of the invention can be used for producing insulation materials, preferably insulation boards, in-situ foams or insulation foams, as are used, for example, in cooling and refrigeration appliances.

A further important field of use for rigid polyurethane or polyisocyanurate foams is insulation boards having flexible covering layers (e.g. aluminium-coated paper), which are used for thermal insulation in the construction of houses and buildings. In addition, there are also composite elements consisting of a rigid foam core and solid metallic covering layers (e.g. steel sheet), which are likewise used as construction elements in the building sector.

The following examples illustrate the present invention by way of example without the invention, whose scope is defined by the entire description and the claims, being restricted to the embodiments mentioned in the examples.

### EXAMPLES

### Foaming Examples

The use-related testing of the formulations according to the invention was carried out using the following foam formulation:

TABLE 2
Formulations for rigid foam applications (rigid
foam panel/insulation board) in parts by mass

| | Formulation | | | |
|---|---|---|---|---|
| | A: PUR | B: PUR | C: PIR | |
| | formulation | formulation | formulation | |
| Polyol | Polyether polyol | Polyether polyol | Stepanpol ® PS | |
| | mixture 100 parts | mixture 100 parts | 2352* 100 parts | |
| TCPP | | | 15 | parts |
| PMDETA | | | 0.2 | parts |
| DMCHA | 1.5 | | — | |
| Kosmos 75 | | | 4.0 | parts |
| DEG | | | | |
| Water | 2 | 0.5 | 0.25 | parts |
| Cyclopentane | 12 | — | | |
| HFC-245fa | — | 18 | | |
| n-Pentane | | | 16 | parts |
| Lecithin | variable | variable | variable | |
| Siloxane | variable | variable | variable | |
| MDI** | 145 parts | 150 parts | 172 | parts |

*Polyester polyol from Stepan
**Desmodur 44V20L: Polymeric MDI from Bayer, 200 mPa*s; 31.5% NCO; functionality 2.7
PMDETA: N,N,N′,N″,N″-Pentamethyldiethylenetriamine
Kosmos 75 DEG: Potassium octoate (75% by weight in diethylene glycol)
DMCHA: N,N-Dimethylcyclohexylamine
TCPP: Tris(1-chloro-2-propyl) phosphate

The foaming examples were carried out by the manual mixing process. For this purpose, the formulations A, B and C containing various siloxanes as described in Table 3 were produced and weighed into a cup. The MDI was subsequently added, the reaction mixture was stirred with a disc stirrer having a diameter of 6 cm for 5 seconds at 3000 rpm and immediately transferred to an aluminium mould which was thermostated to 50° C. and had a size of 50 cm×25 cm×5 cm and was lined with polyethylene film. The amount of foam formulation used was calculated so that it was 10% above the amount required to just fill the mould. After a curing time of 10 minutes, the foams were taken from the mould.

In the case of formulations A and B, the solubility behaviour of the polyol component, i.e. the mixture without isocyanate, was additionally examined. In many cases, it is important for the polyol component to be storage-stable for a long time, i.e. not display phase separation or, even better, be a clear mixture.

The results of the foaming experiments are summarized in Table 3. This shows the surfactants used in each case (Surf.), the systems (Syst.), the amount (Amt.) of the surfactants in parts by mass per 100 parts of polyol, the solubility behaviour (Solub.) of the polyol mixture, the density of the foams in kg/m³ and the λ in mW/m·K. In the comparative examples which are not according to the invention, the siloxanes TEGOSTAB B 8462, B 8481 and B 8871 were used or the experiment was carried out without surfactant. LECICO F 100 from Lecico GmbH was used as lecithin.

TABLE 3
Overview of the foaming results:

| Ex. | Surf. | Syst. | Amt. | Solub. | Density | λ |
|---|---|---|---|---|---|---|
| 1 | — | A | 0 | 24 h | 35.1 | 32.3 |
| *) | | | | | | |
| 2 | Lecithin | A | 2.5 | >30 d | 31.1 | 24.4 |
| | | | | (clear) | | |
| 3 | B 8462 | A | 2.5 | 30 d | 29.5 | 22.5 |
| *) | | | | (turbid) | | |
| 4 | B8462/ | A | 1.25/ | >30 d | 30.1 | 23.3 |
| | lecithin | | 1.25 | (clear) | | |
| 5 | B8462 | A | 1.25 | 24 h | 31.9 | 31.2 |
| *) | | | | | | |
| 6 | Lecithin | B | 2.3 | 14 d | 24.2 | 21.6 |
| | | | | (clear) | | |
| 7 | B 8481 | B | 2.3 | 14 d | 23.1 | 20.9 |
| *) | | | | (turbid) | | |
| 8 | B 8481/ | B | 1.15/ | 14 d | 24.5 | 22.2 |
| | lecithin | | 1.15 | (clear) | | |
| 9 | — | C | 0 | n.d. | 31.1 | 25.2 |
| *) | | | | | | |
| 10 | Lecithin | C | 2.0 | n.d. | 27.9 | 21.6 |

*) Examples not according to the invention

The λ-value is more commonly known as K-factor in the English speaking countries, i.e. the thermal conductivity that is measured according to the SI-system in mW/m·K. (the US unit of measurement for the K-factor is “btu”).

The values reported for solubility have the meaning: when only a time is given, phase separation was observed after this time. If a time is given with the comment (clear) or (turbid), this means that no phase separation was observed up to this point in time but turbidity was sometimes observed.

The examples used in system A show that the foaming experiments using lecithin lead to rigid PU foams which meet technical requirements.

In addition, the use of lecithin has the advantage that the polyol mixture is storage-stable and clear for a longer time (at least 4 days). This can be seen by comparing Example 2 with Examples 1 or 3 and Example 4 with Example 5 as well as Examples 6 and 8 with Example 7.

An analogous effect was observed in the foaming of formulation B.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A composition which is suitable for producing rigid polyurethane foams and comprises at least one lecithin, at least one urethane and/or isocyanurate catalyst, at least one blowing agent, at least one isocyanate component and at least one polyol component, characterized in that the mass ratio of lecithin to polyol component is less than 2.5:100.

2. The composition according to claim 1, characterized in that water is optionally present in the composition and the mass ratio of water to polyol component is less than 5:100.

3. The composition according to claim 1, characterized in that the index is greater than 150.

4. The composition according to claim 1, characterized in that the mass ratio of polyol component to isocyanate component is greater than 1.

5. The composition according to claim 1, characterized in that polyester polyols based on aromatic acids or aliphatic acids which have less than 10 carbon atoms are present as polyol component.

6. The composition according to claim 1, characterized in that a blowing agent is present and the mass ratio of blowing agent to polyol component is 1-30:100.

7. The composition according to claim 6, characterized in that the blowing agent is selected from among hydrocarbons having 5 carbon atoms and halogenated hydrocarbons.

8. The composition according to claim 2, characterized in that the index is greater than 150; the mass ratio of polyol component to isocyanate component is greater than 1; the polyester polyols based on aromatic acids or aliphatic acids which have less than 10 carbon atoms are present; a blowing agent is present and the mass ratio of blowing agent to polyol component is 1-30:100 wherein the blowing agent is selected from among hydrocarbons having 5 carbon atoms and halogenated hydrocarbons.

9. A process for producing rigid polyurethane or polyisocyanurate foams, characterized in that a composition according to claim 1 is used.

10. A rigid polyurethane or polyisocyanurate foams which can be obtained by foaming a composition according to claim 1.

11. A method of improving the insulation properties of insulation materials, insulation boards, in-situ foams or insulation foams which comprise of adding the rigid polyurethane or polyisocyanurate foams according to claim 10.
